(19) United States
(12) Patent Application Publication
(10) Pub. No.: US 2008/0037404 A1
(43) Pub. Date: Feb. 14, 2008

(54) Optical Disc Recording/Reproduction Device

(75) Inventor: Naoki Yumiyama, Ehime (JP)

Correspondence Address: STEPTOE & JOHNSON LLP, 1330 CONNECTICUT AVE., NW, WASHINGTON, DC, 20036, US

(73) Assignee: Matsushita Electric Industrial Co., Ltd., Osaka (JP)

(21) Appl. No.: 11/547,287

(22) PCT Filed: Apr. 8, 2005
(86) PCT No.: PCT/JP05/06949

§ 371 Date: Oct. 3, 2006

(30) Foreign Application Priority Data
Apr. 12, 2004 (JP) 2004-116291

(51) Int. Cl. G11B 7/24; G11B 7/00

(52) U.S. Cl. 369/275.3; 369/112.01

(57) ABSTRACT

An optical disc recording/reproduction device is provided, in which a tracking drive offset amount (21) is given to a tracking drive signal (19), a beam spot position irradiated on a photo-detector (7) is shifted by a servo controller (18), and a CPU (16) detects a divided wobble signal balance being data-recorded. The CPU (16) causes a memory (17) to store the tracking drive offset amounts at which the wobble signal balance is uniform according to the wobble signal balance and the tracking drive offset amount. Further, the CPU (16) controls the beam spot position by adding the tracking drive offset amount read out from the memory (17) to the tracking drive signal (19) when performing recording or reproducing to/from the optical disc.

### TECHNICAL FIELD

The present invention relates to an optical disc recording/reproduction device for use in a CD/DVD recording/reproducing-type drive and the like.

### BACKGROUND ART

For example, JP63-173237A discloses a tracking control circuit for detecting and correcting a manufacturing error in an optical disc reproduction device. Herein, the following technique is adopted.

When a part having an error is actuated, a tracking control circuit disadvantageously generates an offset voltage (a tracking drive offset amount). Unless the offset voltage is compensated, the tracking control circuit operates asymmetrically. However, the tracking control circuit must operate symmetrically, and a control region thereof must be symmetrical.

Hence, upon production of an optical disc reproduction device, an optical scanning unit of the optical disc reproduction device is configured and realized so as to promptly and automatically compensate an offset voltage by means of a simple manner such that a tracking control circuit can operate symmetrically.

### DISCLOSURE OF THE INVENTION

Problems to be Solved by the Invention

However, as described above, if the offset voltage (the tracking drive offset amount) is given such that the control region becomes symmetric, the following problems arise upon recording/reproduction of data. FIG. 3 illustrates a conventional typical optical disc recording/reproduction device. As illustrated in FIG. 3, a photo-detector 7 is divided into four regions A to D.

As shown by a broken line in FIG. 4, “CHARACTERISTIC 1” indicates a relation between a tracking drive offset amount and a jitter value of a bi-phase signal obtained from a wobble signal (a wobble signal in FIG. 3 during reproduction) with time information extracted therefrom. The tracking drive offset amount shown in FIG. 4 is measured in a deviation amount at a spot position of a laser beam connected on the photo-detector 7. This deviation amount is caused by addition of an offset amount to tracking drive.

In normal recording/reproduction devices, characteristics thereof are various and circuits thereof are also various; therefore, a relation between a tracking drive offset amount and a jitter value does not necessarily vary symmetrically with respect to an axis. Indeed, in most cases, such a relation varies asymmetrically. In a recording/reproduction device having a characteristic as shown by “CHARACTERISTIC 1” in FIG. 4, a point at which a jitter value is minimum, that is, a tracking drive offset amount at which suitable read performance is achieved is +200 μm.

Next, description will be given of a flow of an address information acquiring process.

First, a wobble signal is binarized to obtain digital data. The binarized signal converted to the digital data is decoded and, then, is subjected to error correction. Thus, a resultant is extracted as data. Hence, as long as a reproduction signal that deteriorates to some extent is normally subjected to error correction, there arises no problem about read performance for ATIP (Absolute Time In Pre-Groove) information.

As shown by a solid line in FIG. 4, “CHARACTERISTIC 2” indicates a relation between the read performance for ATIP information after the error correction and the tracking drive offset amount. Briefly, the error correction makes it possible to change a relation between a tracking drive offset amount and a jitter value from “CHARACTERISTIC 1” to “CHARACTERISTIC 2”.

In “CHARACTERISTIC 2”, if a tracking drive offset amount falls within a range of ±400 μm, an ATIP error takes a value of “0” without any change. More specifically, it is assumed herein that a tracking drive offset amount having a margin for read performance is obtained from the relation between the tracking drive offset amount and the ATIP error. The tracking drive offset amount that falls within a range of ±400 μm has an invariant value of the ATIP error as described above. Therefore, such a tracking drive offset amount is set at an intermediate value in this range. In FIG. 4, this intermediate value is “0 μm”.

Herein, consideration will be made to a case that read performance for ATIP information deteriorates due to, for example, an influence of a temperature characteristic of a circuit or an element during data recording/reproduction in such a state that tracking drive is controlled so as to achieve “0 μm” of a tracking drive offset amount. As compared with “CHARACTERISTIC 1” in FIG. 4, read performance in “CHARACTERISTIC 3” shown by a chain line deteriorates due to the aforementioned reasons.

It can be confirmed in “CHARACTERISTIC 3” that a state of an ATIP error at “0 μm” of a tracking drive offset amount exceeds a critical level JL of a jitter value, causing an address read error. More specifically, when data is recorded to/reproduced from an optical disc by means of a tracking drive offset amount derived from a relation between a tracking drive amount offset amount and an ATIP error value, an allowance with respect to performance is decreased due to an influence of a change in environment or the like, so that an error is caused.

As for the quality of a recording/reproduction signal, a tracking drive offset amount at which an error count is minimum during data recording does not necessarily correspond with a tracking drive offset amount that becomes most preferable during data reproduction. That is, this means the following factors.

As shown by a broken line in FIG. 5, “CHARACTERISTIC 4” indicates a variation in wobble jitter value in a case that a track on an optical disc on which pits are recorded is traced while a spot position of a laser beam connected on the photo-detector 7 illustrated in FIG. 3 is gradually shifted toward the regions A and D illustrated in FIG. 3 or toward the regions B and C illustrated in FIG. 3.

As shown by a solid line in FIG. 5, “CHARACTERISTIC 5” indicates a variation in wobble jitter value in a case that the spot position of the laser beam is gradually shifted toward the regions A and D illustrated in FIG. 3 or toward the regions B and C illustrated in FIG. 3 during recording of data to the optical disc.

As shown in FIG. 5, a tracking drive offset amount at which a wobble jitter value is minimum in “CHARACTERISTIC 4” does not correspond with that in “CHARACTERISTIC 5”. In the example shown in FIG. 5, a recording state in a case that a tracking drive offset amount at which a wobble jitter value during data reproduction is minimum is set at +200 μm is poorer than a recording state in a case that the tracking drive offset amount at which the wobble jitter value during data reproduction is minimum is set at −200 μm.

In other words, in order to stably record data to an optical disc, a tracking drive offset amount of an optical disc on which pits are not recorded must be set at −200 μm.

The aforementioned description is given of a relation between a tracking drive offset amount and a wobble jitter value; however, the same holds true for a relation between the tracking drive offset amount, and a wobble signal balance, a lens error signal and an ATIP read error count.

An object of the present invention is to provide an optical disc recording/reproduction device capable of stably recording/reproducing data to/from an optical disc.

Means for Solving the Problems

The present invention provides an optical disc recording/reproduction device comprising: a photo-detector for receiving and detecting a laser beam reflected from an optical disc; means for generating a tracking error signal based on an output from the photo-detector; and means for generating a tracking drive signal based on the tracking error signal, the optical disc recording/reproduction device further comprising: means for giving a tracking drive offset amount to the tracking drive signal to shift a spot position of the laser beam irradiated on the photo-detector; means for shifting the spot position of the laser beam irradiated on the photo-detector, and detecting a divided wobble signal balance during data recording; and means for storing a tracking drive offset amount at which the wobble signal balance is uniform, based on the wobble signal balance and the tracking drive offset amount, wherein upon recording/reproduction of data to/from the optical disc, the tracking drive offset amount is added to the tracking drive signal.

The present invention also provides an optical disc recording/reproduction device comprising: means for giving a tracking drive offset amount to a tracking drive signal to shift a spot position of a laser beam irradiated on a photo-detector; means for shifting the spot position of the laser beam irradiated on the photo-detector, and detecting a lens error signal during data recording; and means for storing a tracking drive offset amount at which the lens error signal is a reference voltage, based on the lens error signal and the tracking drive offset amount, wherein upon recording/reproduction of data to/from the optical disc, the tracking drive offset amount is added to the tracking drive signal.

The present invention also provides an optical disc recording/reproduction device comprising: means for giving a tracking drive offset amount to a tracking drive signal to shift a spot position of a laser beam irradiated on a photo-detector; means for shifting the spot position of the laser beam irradiated on the photo-detector, and detecting a wobble signal jitter value during data recording; and means for storing a tracking drive offset amount at which the wobble signal jitter value is minimum, based on the wobble signal jitter value and the tracking drive offset amount, wherein upon recording/reproduction of data to/from the optical disc, the tracking drive offset amount is added to the tracking drive signal.

The present invention also provides an optical disc recording/reproduction device comprising: means for giving a tracking drive offset amount to a tracking drive signal to shift a spot position of a laser beam irradiated on a photo-detector; means for shifting the spot position of the laser beam irradiated on the photo-detector, and detecting an absolute time in pre-groove information read error count during data recording; and means for storing a tracking drive offset amount at which the absolute time in pre-groove information read error count is minimum, based on the absolute time in pre-groove information read error count and the tracking drive offset amount, wherein upon recording/reproduction of data to/from the optical disc, the tracking drive offset amount is added to the tracking drive signal.

The present invention also provides an optical disc recording/reproduction device configured to multiply a difference between two tracking drive offset amounts derived from different methods by a certain ratio to thereby calculate and store a final tracking drive offset amount, and add the final tracking drive offset amount to a tracking drive signal upon recording/reproduction of data to/from an optical disc.

The present invention also provides a control method of an optical disc recording/reproduction device for recording/reproducing data to/from an optical disc in such a manner that a tracking actuator drives an objective lens so that a laser beam is converged to the optical disc, a photo-detector detects the laser beam reflected from the optical disc, and an offset is added to a tracking drive signal for controlling the tracking actuator such that the laser beam converged to the optical disc by the objective lens is located on a center of a track on the optical disc, the control method comprising: shifting a spot position of the laser beam irradiated on the photo-detector, and storing an offset amount based on at least one of the following tracking drive offset amounts obtained during data recording: (1) a tracking drive offset amount at which a divided wobble signal balance is uniform, (2) a tracking drive offset amount at which a lens error signal is a reference voltage, (3) a tracking drive offset amount at which a wobble signal jitter value is minimum, and (4) a tracking drive offset amount at which an absolute time in pre-groove information read error count is minimum, prior to the data recording/reproduction; and adding a final tracking drive offset amount to the tracking drive signal to thereby control a position of the objective lens upon recording/reproduction of data to/from the optical disc.

The present invention also provides an optical disc recording/reproduction device comprising: a photo-detector for receiving and detecting a laser beam reflected from an optical disc; means for generating a tracking error signal based on an output from the photo-detector; means for generating a tracking drive signal based on the tracking error signal; means for giving a bias value to the tracking drive signal to shift a spot position of the laser beam irradiated on the photo-detector; means for shifting the spot position of the laser beam irradiated on the photo-detector, reproducing data recorded to the optical disc, and detecting a jitter value of a reproduction signal; and means for recording a tracking drive offset amount at which the jitter value of the reproduction signal is minimum, based on the jitter value and the tracking drive offset amount. Upon recording/reproduction of data to/from an optical disc, a spot position of a laser beam is shifted from a center by a tracking drive offset amount at which a jitter value of a reproduction signal recorded in a memory is minimum. Thus, the data can be recorded to/reproduced from the optical disc in the most stable state.

The present invention also provides an optical disc recording/reproduction device comprising: a photo-detector for receiving and detecting a laser beam reflected from an optical disc; means for generating a tracking error signal based on an output from the photo-detector; means for generating a tracking drive signal based on the tracking error signal; means for giving a bias value to the tracking drive signal to shift a spot position of the laser beam irradiated on the photo-detector; means for shifting the spot position of the laser beam irradiated on the photo-detector, reproducing data recorded to the optical disc, and detecting an error rate of a reproduction signal; and means for recording a tracking drive offset amount at which the error rate of the reproduction signal is minimum, based on the error rate and the tracking drive offset amount. Upon recording/reproduction of data to/from an optical disc, a spot position of a laser beam is shifted from a center by a tracking drive offset amount at which an error rate of a reproduction signal recorded in a memory is minimum. Thus, the data can be recorded to/reproduced from the optical disc in the most stable state.

Effect of the Invention

According to the present invention, a tracking drive offset amount is obtained so as to make a data recording/reproduction state stable. During the data recording/reproduction, the obtained tracking drive offset amount is added to a tracking drive signal. Thus, it is possible to stably record/reproduce data to/from an optical disc in each optical disc recording/reproduction device.

### BRIEF DESCRIPTION OF THE DRAWINGS

FIG. 1 illustrates a configuration of an optical disc recording/reproduction device according to the present invention.

FIG. 2 illustrates a configuration of the optical disc recording/reproduction device according to the present invention.

FIG. 3 illustrates a configuration of a typical optical disc recording/reproduction device.

FIG. 4 represents a problem of a conventional technique, and shows a relation between a tracking drive offset amount, and an address error and a jitter value.

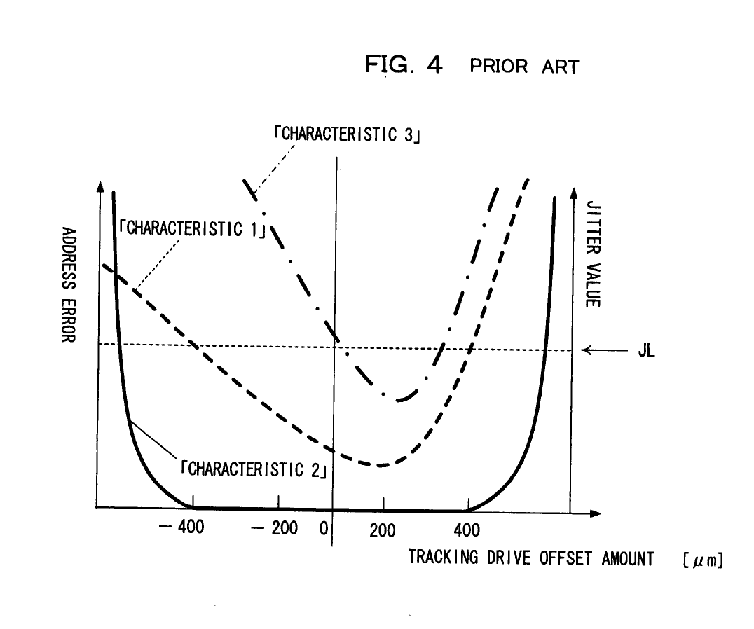

FIG. 5 represents a problem of a conventional technique, and shows a relation between a tracking drive offset amount and a jitter value.

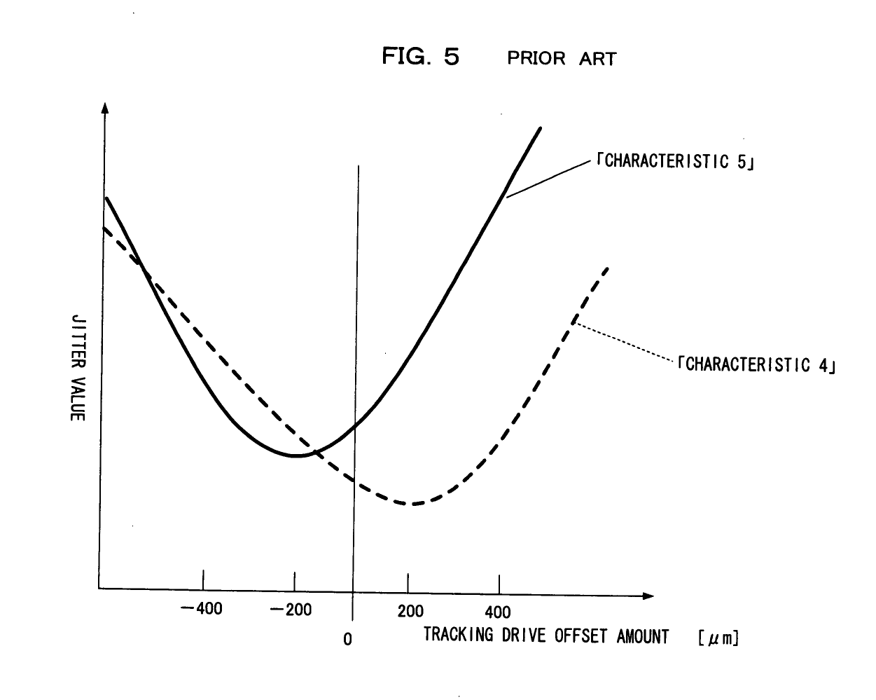

### BEST MODE FOR CARRYING OUT THE INVENTION

Hereinafter, description will be given of embodiments of the present invention.

### Embodiment 1

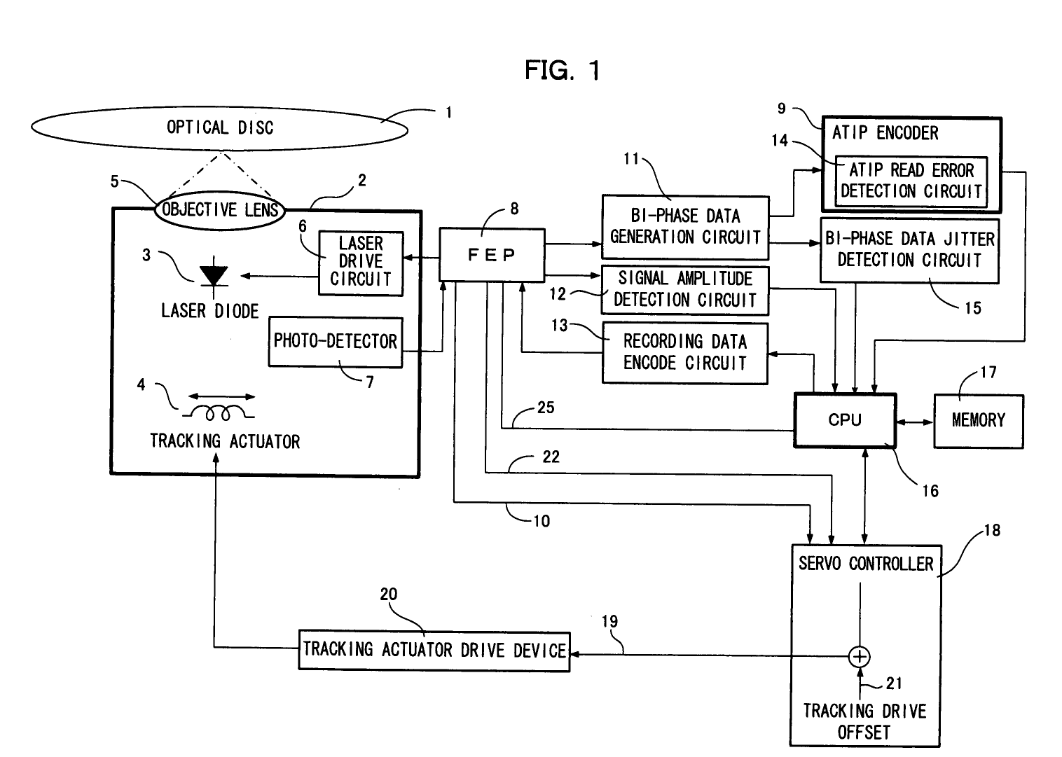

FIG. 1 illustrates an optical disc recording/reproduction device according to the present invention.

Initially, description will be given of tracking servo.

A laser beam emitted from a laser diode 3 of an optical pickup 2 is converged to a track on an optical disc 1 by an objective lens 5. The laser beam reflected from the optical disc 1 passes through the objective lens 5 and, then, is received by a photo-detector 7.

The photo-detector 7 converts the received laser beam to an electric signal, and outputs the electric signal to an FEP (Front End Processor: in a typical optical disc device, an LSI having a function of extracting analog signals for data read, laser control, servo control and address reproduction based on an electric signal converted from light by an optical pickup) 8. The FEP 8 determines a physical shape of the optical disc 1, brightness of reflection, and the like based on the laser beam reflected from the optical disc 1, converts the laser beam to an electric signal, and generates a tracking error signal 10 from the received signal.

The generated tracking error signal 10 has a level varying in accordance with a relative distance between the laser beam converged to the optical disc 1 by the objective lens 5 and the track on the optical disc 1.

The FEP 8 outputs the tracking error signal 10 to a servo controller 18. The servo controller 18 controls a tracking actuator drive device 20 by means of a tracking drive signal 19 based on information of the tracking error signal 10. Further, the servo controller 18 drives a tracking actuator 4 so as to make constant the relative distance between the laser beam converged to the optical disc 1 and the track on the optical disc 1. Herein, the servo controller 18 has a function of adding an offset to a tracking drive signal.

When a CPU 16 instructs the servo controller 18 to add a tracking drive offset 21 to the tracking drive signal 19, the servo controller 18 fixes a spot position of the laser beam converged to the photo-detector 7 at an optional position.

Next, description will be given of data recording.

A recording data encode circuit 13 receives an instruction from the CPU 16 and, then, encodes data to be recorded to an optical disc. The recording data encode circuit 13 transmits the encoded data to the FEP 8. The FEP 8 transmits a signal based on the encoded data to the laser drive circuit 6 of the optical pickup 2. The laser drive circuit 6 drives the laser diode 3 based on the signal transmitted from the FEP 8. In the laser drive circuit 6, the laser beam emitted from the laser diode 3 passes through the objective lens 5 and, then, is converged to the optical disc 1. Thus, pits are recorded on the optical disc 1 by the converged laser beam.

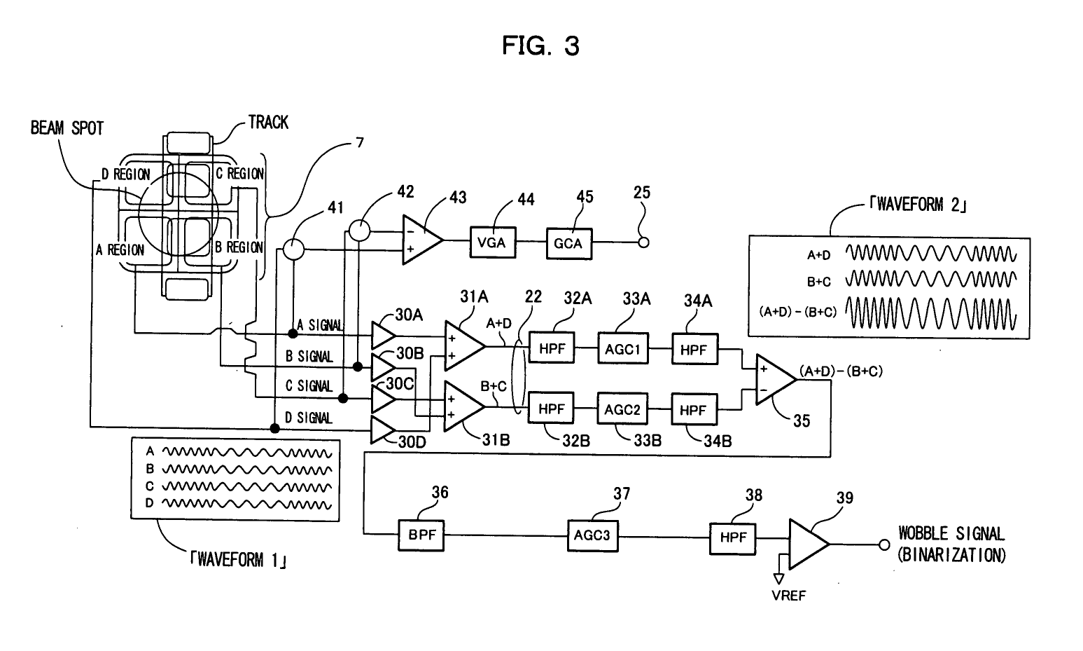

Next, description will be given of an operation of binirizing a wobble signal, performed by the FEP 8, with reference to FIG. 3.

In the following description, there is used as one example the photo-detector 7 divided into four regions A, B, C and D.

The regions A, B, C and D oscillate, respectively, like A, B, C and D shown in “WAVEFORM 1” in FIG. 3. Amplifiers 30A, 30B, 30C and 30D amplify signals of the respective regions A, B, C and D at a certain level. An adder 31A adds the signal A to the signal D to thereby obtain a signal (A+D). An adder 31B adds the signal B to the signal C to thereby obtain a signal (B+C). The signals (A+D) and (B+C) are shown in “WAVEFORM 2” in FIG. 3.

When the signal (A+D) passes through a high-pass filter (HPF) 32A, an automatic gain control circuit (AGC1) 33A and an HPF 34A, noise is removed therefrom and a waveform amplitude thereof is made constant. Similarly, when the signal (B+C) passes through an HPF 32B, an automatic gain control circuit (AGC2) 33B and an HPF 34B, noise is removed therefrom and a waveform amplitude thereof is made constant.

Thereafter, a subtracter 35 performs a subtraction: (A+D)−(B+C). A waveform as a result of this subtraction is shown in “WAVEFORM 2” in FIG. 3. The subtracter 35 outputs a wobble signal binarized as follows. A signal passes through a band pass filter (BPF) 36, an automatic gain control circuit (AGC3) 37 and an HPF 38; thus, noise is removed therefrom and an amplitude thereof is made constant. Thereafter, a comparator 39 compares the signal with a reference voltage VREF.

Based on the aforementioned description, next, detailed description will be given of an operation of the optical disc recording/reproduction device according to the present invention with reference to FIG. 1.

Herein, description will be given of a mechanism that a tracking drive offset 21 is added in order that data is stably recorded to/reproduced from the optical disc 1 by a wobble signal (A+D, B+C) 22 generated in the FEP 8.

In a state that data is recorded to/reproduced from the optical disc 1, the CPU 16 instructs the servo controller 18 to gradually add the tracking drive offset 21 to the tracking drive signal 19.

Herein, “data is recorded to/recorded from” means that a wobble signal is reproduced while data is recorded.

In accordance with the instruction from the CPU 16, the servo controller 18 adds the tracking drive offset 21 to the tracking control signal 19. By the addition of the tracking drive offset 21 to the tracking control signal 19, the tracking actuator drive device 20 drives the tracking actuator 4; thus, the spot position of the laser beam converged to the photo-detector 7 by the objective lens 5 is shifted gradually.

After the addition of the tracking drive offset 21 to the tracking drive signal 19 within a necessary range, the recording/reproduction operation is finished. During the aforementioned process, the laser beam reflected from the optical disc 1 passes through the objective lens 5 and, then, is received by the photo-detector 7. The photo-detector 7 converts the received laser beam to an electric signal and, then, outputs the electric signal to the FEP 8. The FEP 8 generates a wobble signal (A+D, B+C) 22 from the electric signal outputted from the photo-detector 7. The FEP 8 outputs the generated wobble signal (A+D, B+C) 22 to the CPU 16, and the CPU 16 measures an amplitude of the wobble signal (A+D, B+C) 22. Thus, the CPU 16 detects a signal amplitude of the wobble signal (A+D, B+C) 22 in accordance with an amount of the tracking drive offset 21 to be added to the tracking drive signal 19. Further, the CPU 16 obtains a tracking drive offset amount at which a balance of the divided wobble signal (A+D, B+C) 22 is uniform, and allows a memory 17 to store the tracking drive offset amount thus obtained.

Further, upon accessing the optical disc 1 after the storage of the tracking drive offset amount in the memory 17, the CPU 16 shifts the spot position of the laser beam from the center of the photo-detector 7 only by the tracking drive offset amount, at which the wobble signal balance is uniform, recorded in the memory 17, and records/reproduces data to/from the optical disc 1. Thus, it is possible to record/reproduce data to/from the optical disc 1 more stably.

### Embodiment 2

In Embodiment 1, the CPU 16 is configured as follows. That is, during data recording, the CPU 16 obtains a tracking drive offset amount at which the balance of the divided wobble signal (A+D, B+C) 22 is uniform, and allows the memory 17 to store the obtained tracking drive offset amount. Upon accessing the optical disc 1, the CPU 16 shifts the spot position of the laser beam from the center of the photo-detector 7 only by the tracking drive offset amount recorded in the memory 17, and records/reproduces data to/from the optical disc 1. However, it can be expected that similar effects to those in Embodiment 1 are achieved even when the CPU 16 is configured as follows.

Initially, description will be given of an operation of generating a lens error signal 25, performed in the FEP 8, with reference to FIG. 3.

From the signals A to D each outputted from the photo-detector 7, a signal (A+D) is generated at an addition point 41 and a signal (B+C) is generated at an addition point 42. Based on the signal (A+D) and the signal (B+C), a subtracter 43 performs the following subtraction: (A+D)−(B+C). Further, a lens error signal 25 is taken out from the subtracter 43 via a VGA (Variable Gain Amplifier) 44 and a GCA (Gain Control Amplifier) 45.

Therefore, if a spot position of a laser beam is located at the center of the photo-detector 7, the lens error signal 25 is set at a reference voltage. If the spot position is shifted in a tracking drive direction (toward the regions A and D or the regions C and D), a voltage varies in accordance with an amount of the shift. In other words, if the lens error signal 25 is set at the reference voltage, the spot position of the laser beam connected on the photo-detector 7 is located at the center of the photo-detector 7; thus, a data recording/reproduction state can be made stable.

Based on the aforementioned description, next, description will be given of a mechanism of adding the tracking drive offset 21 such that the lens error signal 25 is a reference voltage, with reference to FIG. 1.

In a state that data is recorded to/reproduced from the optical disc 1, the CPU 16 instructs the servo controller 18 to gradually add the tracking drive offset 21 to the tracking drive signal 19. In accordance with the instruction from the CPU 16, the servo controller 18 adds the tracking drive offset 21 to the tracking drive signal 19. By the addition of the tracking drive offset 21 to the tracking drive signal 19, a spot position of a laser beam to be converged to the photo-detector 7 by the objective lens 5 is shifted gradually.

After the addition of the tracking drive offset 21 to the tracking drive signal 19 within a necessary range, the recording/reproduction operation is finished. During the aforementioned process, the laser beam reflected from the optical disc 1 passes through the objective lens 5 and, then, is received by the photo-detector 7. The photo-detector 7 converts the received laser beam to an electric signal and, then, outputs the electric signal to the FEP 8.

The FEP 8 generates a lens error signal 25 from the electric signal outputted from the photo-detector 7. The FEP 8 outputs the generated lens error signal 25 to the CPU 16. Thus, the CPU 16 detects a voltage of the lens error signal 25 in accordance with an amount of the tracking drive offset. Further, the CPU 16 obtains a tracking drive offset amount in a state that the lens error signal 25 is set at a reference potential, and allows the memory 17 to store the tracking drive offset amount thus obtained.

Further, upon accessing the optical disc 1 after the storage of the tracking drive offset amount in the memory 17, the CPU 16 shifts the spot position of the laser beam from the center of the photo-detector 7 only by the tracking drive offset amount, at which the lens error signal 25 is set at a reference potential, recorded in the memory 17, and records/reproduces data to/from the optical disc 1. Thus, it is possible to record/reproduce data to/from the optical disc 1 more stably.

### Embodiment 3

In Embodiment 1, the CPU 16 is configured as follows. That is, during data recording, the CPU 16 obtains a tracking drive offset amount at which the balance of the divided wobble signal (A+D, B+C) 22 is uniform, and allows the memory 17 to store the obtained tracking drive offset amount. Upon accessing the optical disc 1, the CPU 16 shifts the spot position of the laser beam from the center of the photo-detector 7 only by the tracking drive offset amount recorded in the memory 17, and records/reproduces data to/from the optical disc 1. However, it can be expected that similar effects to those in Embodiment 1 are achieved even when the CPU 16 is configured as follows.

Initially, description will be given of a bi-phase data jitter detection circuit 15 with reference to FIG. 1.

An output current of the laser drive circuit 6 controlled by the FEP 8 flows in the laser diode 3. The laser diode 3 emits a laser beam having an output amount in accordance with an amount of the current flowing therein.

The emitted laser beam is converged to the optical disc 1 by the objective lens 5. The laser beam reflected from the optical disc 1 passes through the objective lens 5 and, then, is received by the photo-detector 7.

The photo-detector 7 converts the received laser beam to an electric signal, and outputs the electric signal to the FEP 8. The FEP 8 generates a wobble signal from the signal outputted from the photo-detector 7. The FEP 8 outputs the generated wobble signal to a bi-phase data generation circuit 11.

The bi-phase data generation circuit 11 extracts bi-phase data from the received wobble signal. More specifically, both ends of a groove on the optical disc 1 are wavy in a frequency-modulation manner. The aforementioned wobble signal contains a frequency-modulated component. The bi-phase data generation circuit 11 extracts the frequency-modulated component from the wobble signal and frequency-demodulates the extracted component to thereby generate bi-phase data.

The bi-phase data generation circuit 11 outputs the bi-phase data to the bi-phase data jitter detection circuit 15. The bi-phase data jitter detection circuit 15 outputs a signal to the CPU 16 in accordance with a jitter amount of the received bi-phase data.

Next, description will be given of a configuration that data is recorded/reproduced by means of the bi-phase data jitter detection circuit 15 such that a data recording/reproduction state of the optical disc 1 becomes most stable.

In a state that data is recorded to/reproduced from the optical disc 1, the CPU 16 instructs the servo controller 18 to gradually add the tracking drive offset 21 to the tracking drive signal 19. In accordance with the instruction from the CPU 16, the servo controller 18 adds the tracking drive offset 21 to the tracking drive signal 19. When the servo controller 18 adds the tracking drive offset 21 to the tracking drive signal 19, the spot position of the laser beam converged to the photo-detector 7 by the objective lens 5 is shifted gradually. After the addition of the tracking drive offset 21 to the tracking drive signal 19 within a necessary range, the recording/reproduction operation is finished.

During the aforementioned process, the laser beam reflected from the optical disc 1 passes through the objective lens 5 and, then, is received by the photo-detector 7. The photo-detector 7 converts the received laser beam to an electric signal, and outputs the electric signal to the FEP 8. The FEP 8 generates a wobble signal from the electric signal outputted from the photo-detector 7. The bi-phase data generation circuit 11 converts address information contained in the generated wobble signal to bi-phase data. Thereafter, the bi-phase data generation circuit 11 outputs the bi-phase data to the bi-phase data jitter detection circuit 15. Herein, the bi-phase data jitter detection circuit 15 detects a wobble jitter value, and outputs the detected wobble jitter value to the CPU 16.

As described above, the bi-phase data jitter detection circuit 15 detects a wobble jitter value in accordance with an amount of the tracking drive offset 21 to be added to the tracking drive signal 19. The CPU 16 obtains a tracking drive offset amount at which the wobble jitter value is minimum, and allows the memory 17 to store the tracking drive offset amount thus obtained.

Further, upon accessing the optical disc 1 after the storage of the tracking drive offset amount in the memory 17, the CPU 16 shifts the spot position of the laser beam from the center of the photo-detector 7 only by the tracking drive offset amount, at which the lens error signal 25 is set at a reference potential, recorded in the memory 17, and records/reproduces data to/from the optical disc 1. Thus, it is possible to record/reproduce data to/from the optical disc 1 more stably.

### Embodiment 4

In Embodiment 1, the CPU 16 is configured as follows. That is, during data recording, the CPU 16 obtains a tracking drive offset amount at which the balance of the divided wobble signal (A+D, B+C) 22 is uniform, and allows the memory 17 to store the obtained tracking drive offset amount. Upon accessing the optical disc 1, the CPU 16 shifts the spot position of the laser beam from the center of the photo-detector 7 only by the tracking drive offset amount recorded in the memory 17, and records/reproduces data to/from the optical disc 1. However, it can be expected that similar effects to those in Embodiment 1 are achieved even when the CPU 16 is configured as follows.

Initially, description will be given of an ATIP read error detection circuit 14 with reference to FIG. 1.

An output current of the laser drive circuit 6 controlled by the FEP 8 flows in the laser diode 3. The laser diode 3 emits a laser beam having an output amount in accordance with an amount of the current flowing therein.

The emitted laser beam is converged to the optical disc 1 by the objective lens 5. The laser beam reflected from the optical disc 1 passes through the objective lens 5 and, then, is received by the photo-detector 7.

The photo-detector 7 converts the received laser beam to an electric signal, and outputs the electric signal to the FEP 8. The FEP 8 generates a wobble signal from the signal outputted from the photo-detector 7. The FEP 8 outputs the generated wobble signal to the bi-phase data generation circuit 11.

The bi-phase data generation circuit 11 extracts bi-phase data from the received wobble signal. More specifically, both ends of a groove on the optical disc 1 are wavy in a frequency-modulation manner. The aforementioned wobble signal contains a frequency-modulated component. The bi-phase data generation circuit 11 extracts the frequency-modulated component from the wobble signal and frequency-demodulates the extracted component to thereby generate bi-phase data.

The bi-phase data generation circuit 11 outputs the bi-phase data to an ATIP decoder 9. The ATIP decoder 9 converts the bi-phase data to address information. Herein, the ATIP read error detection circuit 14 counts up an error, and outputs the count to the CPU 16.

Next, description will be given of a configuration that data is recorded to/reproduced from the optical disc 1 by means of the ATIP read error detection circuit 14 such that a data recording/reproduction state of the optical disc 1 becomes most stable.

In a state that data is recorded to/reproduced from the optical disc 1, the CPU 16 instructs the servo controller 18 to gradually add the tracking drive offset 21 to the tracking drive signal 19. In accordance with the instruction from the CPU 16, the servo controller 18 adds the tracking drive offset 21 to the tracking drive signal 19. When the servo controller 18 adds the tracking drive offset 21 to the tracking drive signal 19, the spot position of the laser beam converged to the photo-detector 7 by the objective lens 5 is shifted gradually. After the addition of the tracking drive offset 21 to the tracking drive signal 19 within a necessary range, the recording/reproduction operation is finished.

During the aforementioned process, the laser beam reflected from the optical disc 1 passes through the objective lens 5 and, then, is received by the photo-detector 7. The photo-detector 7 converts the received laser beam to an electric signal, and outputs the electric signal to the FEP 8. The FEP 8 generates a wobble signal from the electric signal outputted from the photo-detector 7. The bi-phase data generation circuit 11 converts address information contained in the generated wobble signal to bi-phase data. Thereafter, the bi-phase data generation circuit 11 outputs the bi-phase data to the ATIP read error detection circuit 14. Herein, the ATIP read error detection circuit 14 detects an ATIP error count, and outputs the detected ATIP error count to the CPU 16.

As described above, the ATIP read error detection circuit 14 detects an ATIP error count in accordance with an amount of the tracking drive offset 21 to be added to the tracking drive signal 19. The CPU 16 obtains a tracking drive offset amount at which the ATIP error count is minimum, and allows the memory 17 to store the tracking drive offset amount thus obtained.

Further, upon accessing the optical disc 1 after the storage of the tracking drive offset amount in the memory 17, the CPU 16 shifts the spot position of the laser beam from the center of the photo-detector 7 only by the tracking drive offset amount, at which the lens error signal 25 is set at a reference potential, recorded in the memory 17, and records/reproduces data to/from the optical disc 1. Thus, it is possible to record/reproduce data to/from the optical disc 1 more stably.

The aforementioned description is given of, as an example, the absolute time in pre-groove information ATIP for use in a CD recordable disc. Such absolute time in pre-groove information differs for each type of an optical disc, and examples thereof include LPP (Land Pre-Pit) in a DVD-R or a DVD-RW, ADIP (Address In Pre-Groove) in a DVD+R or a DVD+RW, CAPA (Complementary Allocated Pit Address) in a DVD-RAM, and the like. That is, the present invention is applicable to all types of absolute time in pre-groove information irrespective of a type of an optical disc.

### Embodiment 5

In Embodiments 1 to 4, the CPU 16 is configured as follows. That is, the CPU 16 adds one of (1) the tracking drive offset amount at which the divided wobble signal balance is uniform, (2) the tracking drive offset amount at which the lens error signal 25 is a reference voltage, (3) the tracking drive offset amount at which the wobble signal jitter value is minimum, and (4) the tracking drive offset amount at which the absolute time in pre-groove information read error count is minimum, each obtained during data recording, to the tracking drive signal 19 upon recording/reproduction of data to/from the optical disc. However, if the CPU 16 is allowed to have the following configuration, data can be recorded to/reproduced from an optical disc more stably in a comprehensive manner at a high grade.

The CPU 16 of the optical disc recording/reproduction device according to Embodiment 5 obtains a tracking drive offset amount at which a divided wobble signal balance is uniform, in accordance with the description in Embodiment 1. Similarly, the CPU 16 obtains a tracking drive offset amount at which the lens error signal 25 is set at a reference voltage, in accordance with the description in Embodiment 2. For example, the CPU 16 allows the memory 17 to store the obtained tracking drive offset amounts independently. Then, the CPU 16 multiplies a difference between the two tracking drive offset amounts by a certain ratio a5 to thereby calculate a comprehensibly stable final tracking drive offset amount.

More specifically, when the tracking drive offset amount obtained in Embodiment 1 is y1 and the tracking drive offset amount obtained in Embodiment 2 is y2, a final tracking drive offset amount z5 to be obtained is calculated from the following equation.
z5=a5·(y1+y2)

Herein, a5 is set such that z5 takes a value between y1 and y2.

The CPU 16 allows the memory 17 to store the final tracking drive offset amount z5 calculated from this equation.

Further, upon accessing the optical disc 1 after the determination of the final tracking drive offset amount z5, the CPU 16 shifts a spot position of a laser beam from the center of the photo-detector 7 only by the final tracking drive offset amount z5, and records/reproduces data to/from the optical disc 1. Thus, it is possible to record/reproduce data to/from the optical disc 1 more stably in a comprehensive manner at a high grade.

### Embodiment 6

In Embodiments 1 to 4, the CPU 16 is configured as follows. That is, the CPU 16 adds one of (1) the tracking drive offset amount at which the divided wobble signal balance is uniform, (2) the tracking drive offset amount at which the lens error signal 25 is a reference voltage, (3) the tracking drive offset amount at which the wobble signal jitter value is minimum, and (4) the tracking drive offset amount at which the absolute time in pre-groove information read error count is minimum, each obtained during data recording, to the tracking drive signal 19 upon recording/reproduction of data to/from the optical disc. However, if the CPU 16 is allowed to have the following configuration, data can be recorded to/reproduced from an optical disc more stably in a comprehensive manner at a high grade.

The CPU 16 of the optical disc recording/reproduction device according to Embodiment 6 obtains a tracking drive offset amount at which a divided wobble signal balance is uniform, in accordance with the description in Embodiment 1. Similarly, the CPU 16 obtains a tracking drive offset amount at which a wobble signal jitter value is minimum, in accordance with the description in Embodiment 3. For example, the CPU 16 allows the memory 17 to store the obtained tracking drive offset amounts independently. Then, the CPU 16 multiplies a difference between the two tracking drive offset amounts by a certain ratio a6 to thereby calculate a comprehensibly stable final tracking drive offset amount.

More specifically, when the tracking drive offset amount obtained in Embodiment 1 is y1 and the tracking drive offset amount obtained in Embodiment 3 is y3, a final tracking drive offset amount z6 to be obtained is calculated from the following equation.
z6=a6·(y1+y3)

Herein, a6 is set such that z6 takes a value between y1 and y3.

The CPU 16 allows the memory 17 to store the final tracking drive offset amount calculated from this equation.

Further, upon accessing the optical disc 1 after the determination of the final tracking drive offset amount z6, the CPU 16 shifts a spot position of a laser beam from the center of the photo-detector 7 only by the final tracking drive offset amount z6, and records/reproduces data to/from the optical disc 1. Thus, it is possible to record/reproduce data to/from the optical disc 1 more stably in a comprehensive manner at a high grade.

### Embodiment 7

In Embodiments 1 to 4, the CPU 16 is configured as follows. That is, the CPU 16 adds one of (1) the tracking drive offset amount at which the divided wobble signal balance is uniform, (2) the tracking drive offset amount at which the lens error signal 25 is a reference voltage, (3) the tracking drive offset amount at which the wobble signal jitter value is minimum, and (4) the tracking drive offset amount at which the absolute time in pre-groove information read error count is minimum, each obtained during data recording, to the tracking drive signal 19 upon recording/reproduction of data to/from the optical disc. However, if the CPU 16 is allowed to have the following configuration, data can be recorded to/reproduced from an optical disc more stably in a comprehensive manner at a high grade.

The CPU 16 of the optical disc recording/reproduction device according to Embodiment 7 obtains a tracking drive offset amount at which a divided wobble signal balance is uniform, in accordance with the description in Embodiment 1. Similarly, the CPU 16 obtains a tracking drive offset amount at which an absolute time in pre-groove information read error count is minimum, in accordance with the description in Embodiment 4. For example, the CPU 16 allows the memory 17 to store the obtained tracking drive offset amounts independently. Then, the CPU 16 multiplies a difference between the two tracking drive offset amounts by a certain ratio a7 to thereby calculate a comprehensibly stable final tracking drive offset amount.

More specifically, when the tracking drive offset amount obtained in Embodiment 1 is y1 and the tracking drive offset amount obtained in Embodiment 4 is y4, a final tracking drive offset amount z7 to be obtained is calculated from the following equation.
z7=a7·(y1+y4)

Herein, a7 is set such that z7 takes a value between y1 and y4.

The CPU 16 allows the memory 17 to store the final tracking drive offset amount calculated from this equation.

Further, upon accessing the optical disc 1 after the determination of the final tracking drive offset amount z7, the CPU 16 shifts a spot position of a laser beam from the center of the photo-detector 7 only by the final tracking drive offset amount z7, and records/reproduces data to/from the optical disc 1. Thus, it is possible to record/reproduce data to/from the optical disc 1 more stably in a comprehensive manner at a high grade.

### Embodiment 8

In Embodiments 1 to 4, the CPU 16 is configured as follows. That is, the CPU 16 adds one of (1) the tracking drive offset amount at which the divided wobble signal balance is uniform, (2) the tracking drive offset amount at which the lens error signal 25 is a reference voltage, (3) the tracking drive offset amount at which the wobble signal jitter value is minimum, and (4) the tracking drive offset amount at which the absolute time in pre-groove information read error count is minimum, each obtained during data recording, to the tracking drive signal 19 upon recording/reproduction of data to/from the optical disc. However, if the CPU 16 is allowed to have the following configuration, data can be recorded to/reproduced from an optical disc more stably in a comprehensive manner at a high grade.

The CPU 16 of the optical disc recording/reproduction device according to Embodiment 8 obtains a tracking drive offset amount at which a lens error signal 25 is a reference voltage, in accordance with the description in Embodiment 2. Similarly, the CPU 16 obtains a tracking drive offset amount at which a wobble signal jitter value is minimum, in accordance with the description in Embodiment 3. For example, the CPU 16 allows the memory 17 to store the obtained tracking drive offset amounts independently. Then, the CPU 16 multiplies a difference between the two tracking drive offset amounts by a certain ratio a8 to thereby calculate a comprehensibly stable final tracking drive offset amount.

More specifically, when the tracking drive offset amount obtained in Embodiment 2 is y2 and the tracking drive offset amount obtained in Embodiment 3 is y3, a final tracking drive offset amount z8 to be obtained is calculated from the following equation.
z8=a8·(y2+y3)

Herein, a8 is set such that z8 takes a value between y2 and y3.

The CPU 16 allows the memory 17 to store the final tracking drive offset amount calculated from this equation.

Further, upon accessing the optical disc 1 after the determination of the final tracking drive offset amount z8, the CPU 16 shifts a spot position of a laser beam from the center of the photo-detector 7 only by the final tracking drive offset amount z8, and records/reproduces data to/from the optical disc 1. Thus, it is possible to record/reproduce data to/from the optical disc 1 more stably in a comprehensive manner at a high grade.

### Embodiment 9

In Embodiments 1 to 4, the CPU 16 is configured as follows. That is, the CPU 16 adds one of (1) the tracking drive offset amount at which the divided wobble signal balance is uniform, (2) the tracking drive offset amount at which the lens error signal 25 is a reference voltage, (3) the tracking drive offset amount at which the wobble signal jitter value is minimum, and (4) the tracking drive offset amount at which the absolute time in pre-groove information read error count is minimum, each obtained during data recording, to the tracking drive signal 19 upon recording/reproduction of data to/from the optical disc. However, if the CPU 16 is allowed to have the following configuration, data can be recorded to/reproduced from an optical disc more stably in a comprehensive manner at a high grade.

The CPU 16 of the optical disc recording/reproduction device according to Embodiment 9 obtains a tracking drive offset amount at which a lens error signal 25 is a reference voltage, in accordance with the description in Embodiment 2. Similarly, the CPU 16 obtains a tracking drive offset amount at which an absolute time in pre-groove information read error count is minimum, in accordance with the description in Embodiment 4. For example, the CPU 16 allows the memory 17 to store the obtained tracking drive offset amounts independently. Then, the CPU 16 multiplies a difference between the two tracking drive offset amounts by a certain ratio a9 to thereby calculate a comprehensibly stable final tracking drive offset amount.

More specifically, when the tracking drive offset amount obtained in Embodiment 2 is y2 and the tracking drive offset amount obtained in Embodiment 4 is y4, a final tracking drive offset amount z9 to be obtained is calculated from the following equation.
z9=a9·(y2+y4)

Herein, a9 is set such that z9 takes a value between y2 and y4.

The CPU 16 allows the memory 17 to store the final tracking drive offset amount z9 calculated from this equation.

Further, upon accessing the optical disc 1 after the determination of the final tracking drive offset amount z9, the CPU 16 shifts a spot position of a laser beam from the center of the photo-detector 7 only by the final tracking drive offset amount z9, and records/reproduces data to/from the optical disc 1. Thus, it is possible to record/reproduce data to/from the optical disc 1 more stably in a comprehensive manner at a high grade.

### Embodiment 10

In Embodiments 1 to 4, the CPU 16 is configured as follows. That is, the CPU 16 adds one of (1) the tracking drive offset amount at which the divided wobble signal balance is uniform, (2) the tracking drive offset amount at which the lens error signal 25 is a reference voltage, (3) the tracking drive offset amount at which the wobble signal jitter value is minimum, and (4) the tracking drive offset amount at which the absolute time in pre-groove information read error count is minimum, each obtained during data recording, to the tracking drive signal 19 upon recording/reproduction of data to/from the optical disc. However, if the CPU 16 is allowed to have the following configuration, data can be recorded to/reproduced from an optical disc more stably in a comprehensive manner at a high grade.

The CPU 16 of the optical disc recording/reproduction device according to Embodiment 10 obtains a tracking drive offset amount at which a wobble signal jitter value is minimum, in accordance with the description in Embodiment 3. Similarly, the CPU 16 obtains a tracking drive offset amount at which an absolute time in pre-groove information read error count is minimum, in accordance with the description in Embodiment 4. For example, the CPU 16 allows the memory 17 to store the obtained tracking drive offset amounts independently. Then, the CPU 16 multiplies a difference between the two tracking drive offset amounts by a certain ratio a10 to thereby calculate a comprehensibly stable final tracking drive offset amount.

More specifically, when the tracking drive offset amount obtained in Embodiment 3 is y3 and the tracking drive offset amount obtained in Embodiment 4 is y4, a final tracking drive offset amount z10 to be obtained is calculated from the following equation.
z10=a10·(y3+y4)

Herein, a10 is set such that z10 takes a value between y3 and y4.

The CPU 16 allows the memory 17 to store the final tracking drive offset amount z10 calculated from this equation.

Further, upon accessing the optical disc 1 after the determination of the final tracking drive offset amount z10, the CPU 16 shifts a spot position of a laser beam from the center of the photo-detector 7 only by the final tracking drive offset amount z10, and records/reproduces data to/from the optical disc 1. Thus, it is possible to record/reproduce data to/from the optical disc 1 more stably in a comprehensive manner at a high grade.

### Embodiment 11

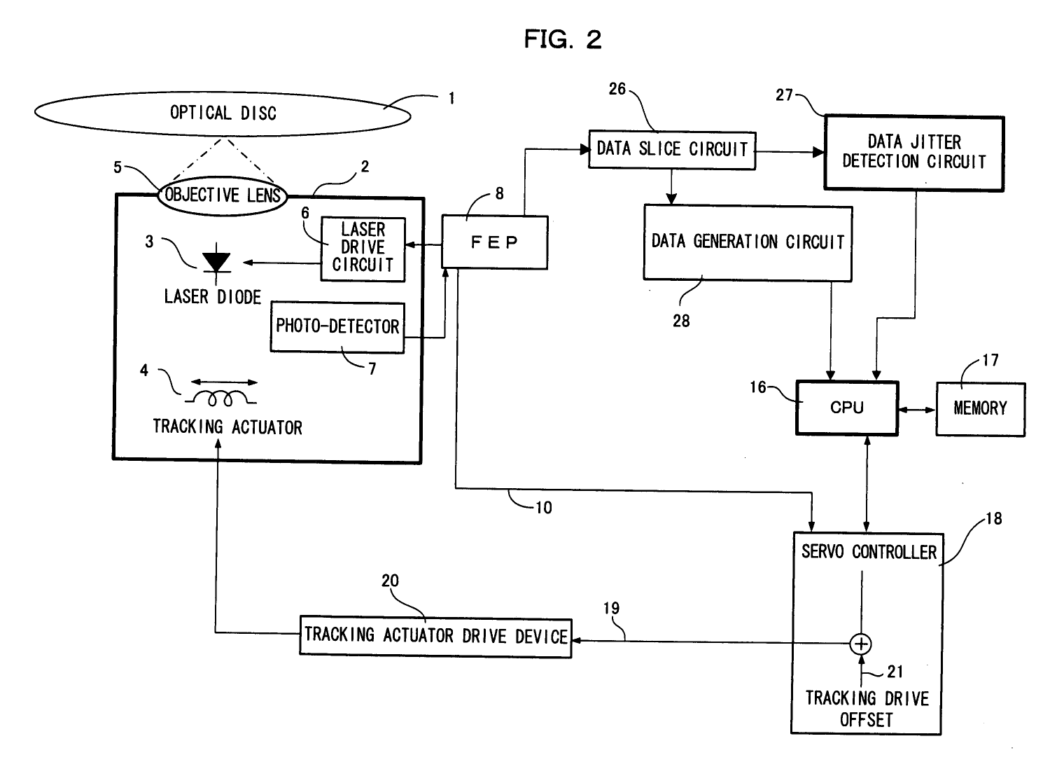

FIG. 2 illustrates the optical disc recording/reproduction device according to the present invention.

Initially, description will be given of tracking servo.

A laser beam emitted from the laser diode 3 is converged to the track on the optical disc 1 by the objective lens 5. The laser beam reflected from the optical disc 1 pass through the objective lens 5 and, then, is received by the photo-detector 7. The photo-detector 7 converts the received laser beam to an electric signal, and outputs the electric signal to the FEP 8. The FEP 8 generates a tracking error signal 10 from the received signal. The generated tracking error signal 10 has a level varying in accordance with a relative distance between the laser beam converged to the optical disc 1 by the objective lens 5 and the track on the optical disc 1. The FEP 8 outputs the tracking error signal 10 to the servo controller 18. The servo controller 18 controls the tracking actuator drive device 20 by means of a tracking drive signal 19 based on information of the tracking error signal 10. Further, the servo controller 18 drives the tracking actuator 4 so as to make constant the relative distance between the laser beam converged to the optical disc 1 and the track on the optical disc 1. Herein, the servo controller 18 has a function of adding an offset to a tracking drive signal 19. Accordingly, when the CPU 16 instructs the servo controller 18 to add a tracking drive offset 21 to the tracking drive signal 19, the servo controller 18 fixes a spot position of the laser beam converged to the photo-detector 7 at an optional position.

Next, description will be given of detection of a reproduction signal jitter value in data recorded to the optical disc 1.

An output current of the laser drive circuit 6 controlled by the FEP 8 flows in the laser diode 3. The laser diode 3 emits a laser beam having an output amount in accordance with an amount of the current flowing therein. The emitted laser beam is converged to the optical disc 1 by the objective lens 5. The laser beam reflected from the optical disc 1 passes through the objective lens 5 and, then, is received by the photo-detector 7. The photo-detector 7 converts the received laser beam to an electric signal, and outputs the electric signal to the FEP 8. The FEP 8 generates an RF signal from the electric signal outputted from the photo-detector 7. A data slice circuit 26 binarizes the RF signal generated by the FEP 8 to obtain a digital signal. The data slice circuit 26 outputs the digital signal thus converted to a data jitter detection circuit 27. The data jitter detection circuit 27 outputs jitter information of the digital signal outputted from the data slice circuit 26 to the CPU 16.

Next, description will be given of a mechanism that data is recorded to/reproduced from the optical disc 1 by means of the data jitter detection circuit 27 in such a manner that a data recording/reproduction state of the optical disc 1 becomes most stable.

While reproducing data from the optical disc 1 having data recorded thereto, the CPU 16 instructs the servo controller 18 to gradually add the tracking drive offset 21 to the tracking drive signal 19. In accordance with the instruction from the CPU 16, the servo controller 18 adds the tracking drive offset 21 to the tracking control signal 19. By the addition of the tracking drive offset 21 to the tracking control signal 19, the spot position of the laser beam converged to the photo-detector 7 by the objective lens 5 is shifted gradually. After the addition of the tracking drive offset 21 to the tracking drive signal 19 within a necessary range, the data reproduction operation is finished.

During the aforementioned process, the laser beam reflected from the optical disc 1 passes through the objective lens 5 and, then, is received by the photo-detector 7. The photo-detector 7 converts the received laser beam to an electric signal and, then, outputs the electric signal to the FEP 8. The FEP 8 generates an RF signal from the electric signal outputted from the photo-detector 7. The data slice circuit 26 binarizes the RF signal generated by the FEP 8 to obtain digital data. The data slice circuit 26 outputs the digital data thus converted to the data jitter detection circuit 27. The data jitter detection circuit 27 detects a jitter value and outputs the detected jitter value to the CPU 16.

Thus, the data jitter detection circuit 27 detects a jitter value in accordance with a tracking drive offset amount, and the CPU 16 obtains a tracking drive offset amount at which the jitter value is minimum. The CPU 16 allows the memory 17 to store the tracking drive offset amount thus obtained. Hereafter, upon recording/reproduction of data to/from the optical disc 1, the tracking drive offset amount recorded in the memory 17 is added to the tracking drive signal 19, so that data can be recorded to/reproduced from the optical disc 1 in the most stable state.

### Embodiment 12

Description will be given of a data generation circuit 28 with reference to FIG. 2.

An output current of the laser drive circuit 6 controlled by the FEP 8 flows in the laser diode 3. The laser diode 3 emits a laser beam having an output amount in accordance with an amount of the current flowing therein. The emitted laser beam is converged to the optical disc 1 by the objective lens 5. The laser beam reflected from the optical disc 1 passes through the objective lens 5 and, then, is received by the photo-detector 7. The photo-detector 7 converts the received laser beam to an electric signal, and outputs the electric signal to the FEP 8. The FEP 8 generates an RF signal from the electric signal outputted from the photo-detector 7. The FEP 8 outputs the generated RF signal to the data generation circuit 28. The data generation circuit 28 performs EFM demodulation based on the received RF signal and, then, performs error correction and error detection to extract data to be recorded. Herein, the data generation circuit 28 outputs an error detection count and an error correction count to the CPU 16.

Next, description will be given of a mechanism that data is recorded to/reproduced from the optical disc 1 by means of the data generation circuit 28 in such a manner that a data recording/reproduction state of the optical disc 1 becomes most stable.

In a state that data is reproduced from the optical disc 1 having data recorded thereto, the CPU 16 instructs the servo controller 18 to gradually add the tracking drive offset 21 to the tracking drive signal 19. In accordance with the instruction from the CPU 16, the servo controller 18 adds the tracking drive offset 21 to the tracking control signal 19. When the servo controller 18 adds the tracking drive offset 21 to the tracking drive signal 19, the spot position of the laser beam converged to the photo-detector 7 by the objective lens 5 is shifted gradually. After the addition of the tracking drive offset 21 to the tracking drive signal 19 within a necessary range, the data reproduction operation is finished.

During the aforementioned process, the laser beam reflected from the optical disc 1 passes through the objective lens 5 and, then, is received by the photo-detector 7. The photo-detector 7 converts the received laser beam to an electric signal and, then, outputs the electric signal to the FEP 8. The FEP 8 generates an RF signal from the electric signal outputted from the photo-detector 7. The FEP 8 outputs the generated RF signal to the data generation circuit 28. The data generation circuit 28 extracts data from the RF signal. During this process, the data generation circuit 28 counts up error correction and error detection and outputs the counts to the CPU 16. Thus, the data generation circuit 28 obtains an error correction count and an error detection count in accordance with an amount of the tracking drive offset 21 to be added to the tracking drive signal 19, and the CPU 16 obtains a tracking drive offset amount at which an error rate is minimum. The CPU 16 allows the memory 17 to store the tracking drive offset amount thus obtained. Hereafter, upon recording/reproduction of data to/from the optical disc 1, the tracking drive offset amount recorded in the memory 17 is added to the tracking drive signal 19, so that data can be recorded to/reproduced from the optical disc 1 in the most stable state.

### Embodiment 13

The CPU 16 obtains a tracking drive offset amount at which a jitter value is minimum, in accordance with the description in Embodiment 11. Similarly, the CPU 16 obtains a tracking drive offset amount at which an error rate is minimum, in accordance with the description in Embodiment 12. When the tracking drive offset amount obtained in Embodiment 11 is x and the tracking drive offset amount obtained in Embodiment 12 is y, a tracking drive offset amount z to be obtained is calculated from the following equation: z=a×(x+y). Herein, a is set such that z takes a value between x and y. By using the tracking drive offset amount calculated from this equation, the CPU 16 shifts a spot position of a laser beam from the center of the photo-detector 7, and records/reproduces data to/from the optical disc 1. Thus, it is possible to record/reproduce data to/from the optical disc 1 in the most stable state in a comprehensive manner at a high grade.

### INDUSTRIAL APPLICABILITY

The present invention is applicable for improving reliability of a CD/DVD recording/reproducing-type drive and various devices including the same.

1. An optical disc recording/reproduction device comprising:
a photo-detector for receiving and detecting a laser beam reflected from an optical disc; means for generating a tracking error signal based on an output from the photo-detector; and means for generating a tracking drive signal based on the tracking error signal, the optical disc recording/reproduction device further comprising:
means for giving a tracking drive offset amount to the tracking drive signal to shift a spot position of the laser beam irradiated on the photo-detector;
means for shifting the spot position of the laser beam irradiated on the photo-detector, and detecting a divided wobble signal balance during data recording; and
means for storing a tracking drive offset amount at which the wobble signal balance is uniform, based on the wobble signal balance and the tracking drive offset amount, wherein
upon recording/reproduction of data to/from the optical disc, the tracking drive offset amount is added to the tracking drive signal.

2. An optical disc recording/reproduction device comprising:
a photo-detector for receiving and detecting a laser beam reflected from an optical disc; means for generating a tracking error signal based on an output from the photo-detector; and means for generating a tracking drive signal based on the tracking error signal, the optical disc recording/reproduction device further comprising:
means for giving a tracking drive offset amount to the tracking drive signal to shift a spot position of the laser beam irradiated on the photo-detector;
means for shifting the spot position of the laser beam irradiated on the photo-detector, and detecting a lens error signal during data recording; and
means for storing a tracking drive offset amount at which the lens error signal is a reference voltage, based on the lens error signal and the tracking drive offset amount, wherein
upon recording/reproduction of data to/from the optical disc, the tracking drive offset amount is added to the tracking drive signal.

3. An optical disc recording/reproduction device comprising:
a photo-detector for receiving and detecting a laser beam reflected from an optical disc; means for generating a tracking error signal based on an output from the photo-detector; and means for generating a tracking drive signal based on the tracking error signal, the optical disc recording/reproduction device further comprising:
means for giving a tracking drive offset amount to the tracking drive signal to shift a spot position of the laser beam irradiated on the photo-detector;
means for shifting the spot position of the laser beam irradiated on the photo-detector, and detecting a wobble signal jitter value during data recording; and
means for storing a tracking drive offset amount at which the wobble signal jitter value is minimum, based on the wobble signal jitter value and the tracking drive offset amount, wherein upon recording/reproduction of data to/from the optical disc, the tracking drive offset amount is added to the tracking drive signal.

4. An optical disc recording/reproduction device comprising:
a photo-detector for receiving and detecting a laser beam reflected from an optical disc; means for generating a tracking error signal based on an output from the photo-detector; and means for generating a tracking drive signal based on the tracking error signal, the optical disc recording/reproduction device further comprising:
means for giving a tracking drive offset amount to the tracking drive signal to shift a spot position of the laser beam irradiated on the photo-detector;
means for shifting the spot position of the laser beam irradiated on the photo-detector, and detecting an absolute time in pre-groove information read error count during data recording; and
means for storing a tracking drive offset amount at which the absolute time in pre-groove information read error count is minimum, based on the absolute time in pre-groove information read error count and the tracking drive offset amount, wherein
upon recording/reproduction of data to/from the optical disc, the tracking drive offset amount is added to the tracking drive signal.

5. An optical disc recording/reproduction device according to claim 1 configured to multiply a difference between
a tracking drive offset amount derived from the claim 1 device, and
a tracking drive offset amount derived from an optical disc recording/reproduction device comprising: a photo-detector for receiving and detecting a laser beam reflected from an optical disc; means for generating a tracking error signal based on an output from the photo-detector; and means for generating a tracking drive signal based on the tracking error signal, the optical disc recording/reproduction device further comprising:
means for giving a tracking drive offset amount to the tracking drive signal to shift a spot position of the laser beam irradiated on the photo-detector;
means for shifting the spot position of the laser beam irradiated on the photo-detector, and detecting a lens error signal during data recording; and
means for storing a tracking drive offset amount at which the lens error signal is a reference voltage, based on the lens error signal and the tracking drive offset amount, wherein
upon recording/reproduction of data to/from the optical disc, the tracking drive offset amount is added to the tracking drive signal,
by a certain ratio to thereby calculate and store a final tracking drive offset amount, and add the final tracking drive offset amount to a tracking drive signal upon recording/reproduction of data to/from an optical disc.

6. An optical disc recording/reproduction device according to claim 1 configured to multiply a difference between
a tracking drive offset amount derived from the claim 1 device, and
a tracking drive offset amount derived from an optical disc recording/reproduction device comprising: a photo-detector for receiving and detecting a laser beam reflected from an optical disc; means for generating a tracking error signal based on an output from the photo-detector; and means for generating a tracking drive signal based on the tracking error signal, the optical disc recording/reproduction device further comprising:
means for giving a tracking drive offset amount to the tracking drive signal to shift a spot position of the laser beam irradiated on the photo-detector;
means for shifting the spot position of the laser beam irradiated on the photo-detector, and detecting a wobble signal jitter value during data recording; and
means for storing a tracking drive offset amount at which the wobble signal jitter value is minimum, based on the wobble signal jitter value and the tracking drive offset amount, wherein
upon recording/reproduction of data to/from the optical disc, the tracking drive offset amount is added to the tracking drive signal,
by a certain ratio to thereby calculate and store a final tracking drive offset amount, and add the final tracking drive offset amount to a tracking drive signal upon recording/reproduction of data to/from an optical disc.

7. An optical disc recording/reproduction device according to claim 1 configured to multiply a difference between
a tracking drive offset amount derived from the claim 1 device, and
a tracking drive offset amount derived from an optical disc recording/reproduction device comprising: a photo-detector for receiving and detecting a laser beam reflected from an optical disc; means for generating a tracking error signal based on an output from the photo-detector; and means for generating a tracking drive signal based on the tracking error signal, the optical disc recording/reproduction device further comprising:
means for giving a tracking drive offset amount to the tracking drive signal to shift a spot position of the laser beam irradiated on the photo-detector;
means for shifting the spot position of the laser beam irradiated on the photo-detector, and detecting an absolute time in pre-groove information read error count during data recording; and
means for storing a tracking drive offset amount at which the absolute time in pre-groove information read error count is minimum, based on the absolute time in pre-groove information read error count and the tracking drive offset amount, wherein
upon recording/reproduction of data to/from the optical disc, the tracking drive offset amount is added to the tracking drive signal,
by a certain ratio to thereby calculate and store a final tracking drive offset amount, and add the final tracking drive offset amount to a tracking drive signal upon recording/reproduction of data to/from an optical disc.

8. An optical disc recording/reproduction device according to claim 2 configured to multiply a difference between
a tracking drive offset amount derived from the claim 2 device, and
a tracking drive offset amount derived from an optical disc recording/reproduction device comprising: a photo-detector for receiving and detecting a laser beam reflected from an optical disc; means for generating a tracking error signal based on an output from the photo-detector; and means for generating a tracking drive signal based on the tracking error signal, the optical disc recording/reproduction device further comprising:
means for giving a tracking drive offset amount to the tracking drive signal to shift a spot position of the laser beam irradiated on the photo-detector;
means for shifting the spot position of the laser beam irradiated on the photo-detector, and detecting a wobble signal jitter value during data recording; and
means for storing a tracking drive offset amount at which the wobble signal jitter value is minimum, based on the wobble signal jitter value and the tracking drive offset amount, wherein
upon recording/reproduction of data to/from the optical disc, the tracking drive offset amount is added to the tracking drive signal,
by a certain ratio to thereby calculate and store a final tracking drive offset amount, and add the final tracking drive offset amount to a tracking drive signal upon recording/reproduction of data to/from an optical disc.

9. An optical disc recording/reproduction device according to claim 2 configured to multiply a difference between
a tracking drive offset amount derived from the claim 2 device, and
a tracking drive offset amount derived from an optical disc recording/reproduction device comprising: a photo-detector for receiving and detecting a laser beam reflected from an optical disc; means for generating a tracking error signal based on an output from the photo-detector; and means for generating a tracking drive signal based on the tracking error signal, the optical disc recording/reproduction device further comprising:
means for giving a tracking drive offset amount to the tracking drive signal to shift a spot position of the laser beam irradiated on the photo-detector;
means for shifting the spot position of the laser beam irradiated on the photo-detector, and detecting an absolute time in pre-groove information read error count during data recording; and
means for storing a tracking drive offset amount at which the absolute time in pre-groove information read error count is minimum, based on the absolute time in pre-groove information read error count and the tracking drive offset amount, wherein
upon recording/reproduction of data to/from the optical disc, the tracking drive offset amount is added to the tracking drive signal,
by a certain ratio to thereby calculate and store a final tracking drive offset amount, and add the final tracking drive offset amount to a tracking drive signal upon recording/reproduction of data to/from an optical disc.

10. An optical disc recording/reproduction device according to claim 3 configured to multiply a difference between
a tracking drive offset amount derived from the claim 3 device, and
a tracking drive offset amount derived from an optical disc recording/reproduction device comprising: a photo-detector for receiving and detecting a laser beam reflected from an optical disc; means for generating a tracking error signal based on an output from the photo-detector; and means for generating a tracking drive signal based on the tracking error signal, the optical disc recording/reproduction device further comprising:
means for giving a tracking drive offset amount to the tracking drive signal to shift a spot position of the laser beam irradiated on the photo-detector;
means for shifting the spot position of the laser beam irradiated on the photo-detector, and detecting an absolute time in pre-groove information read error count during data recording; and
means for storing a tracking drive offset amount at which the absolute time in pre-groove information read error count is minimum, based on the absolute time in pre-groove information read error count and the tracking drive offset amount, wherein
upon recording/reproduction of data to/from the optical disc, the tracking drive offset amount is added to the tracking drive signal,
by a certain ratio to thereby calculate and store a final tracking drive offset amount, and add the final tracking drive offset amount to the tracking drive signal upon recording/reproduction of data to/from an optical disc.

11. A control method of an optical disc recording/reproduction device for recording/reproducing data to/from an optical disc in such a manner that a tracking actuator drives an objective lens so that a laser beam is converged to the optical disc, a photo-detector detects the laser beam reflected from the optical disc, and an offset is added to a tracking drive signal for controlling the tracking actuator such that the laser beam converged to the optical disc by the objective lens is located on a center of a track on the optical disc, the control method comprising:
shifting a spot position of the laser beam irradiated on the photo-detector, and storing an offset amount based on at least one of (1) a tracking drive offset amount at which a divided wobble signal balance is uniform, (2) a tracking drive offset amount at which a lens error signal is a reference voltage, (3) a tracking drive offset amount at which a wobble signal jitter value is minimum, and (4) a tracking drive offset amount at which an absolute time in pre-groove information read error count is minimum, each obtained during data recording, prior to the data recording/reproduction; and
adding a final tracking drive offset amount to the tracking drive signal to thereby control a position of the objective lens upon recording/reproduction of data to/from the optical disc.

12. An optical disc recording/reproduction device comprising: a photo-detector for receiving and detecting a laser beam reflected from an optical disc; means for generating a tracking error signal based on an output from the photo-detector; and means for generating a tracking drive signal based on the tracking err)r signal, the optical disc recording/reproduction device further comprising:
means for giving a tracking drive offset amount to the tracking drive signal to shift a spot position of the laser beam irradiated on the photo-detector;
means for shifting the spot position of the laser beam irradiated on the photo-detector, reproducing data recorded to the optical disc, and detecting a jitter value of a reproduction signal; and
means for recording a tracking drive offset amount at which the jitter value of the data recorded to the optical disc is minimum, based on the jitter value and the tracking drive offset amount, wherein
upon recording/reproduction of data to/from the optical disc, the tracking drive offset amount is added to the tracking drive signal.

13. An optical disc recording/reproduction device comprising: a photo-detector for receiving and detecting a laser beam reflected from an optical disc; means for generating a tracking error signal based on an output from the photo-detector; and means for generating a tracking drive signal based on the tracking error signal, the optical disc recording/reproduction device further comprising:
means for giving a tracking drive offset amount to the tracking drive signal to shift a spot position of the laser beam irradiated on the photo-detector;
means for shifting the spot position of the laser beam irradiated on the photo-detector, reproducing data recorded to the optical disc, and detecting an error rate; and
means for recording a tracking drive offset amount at which the error rate of the data recorded to the optical disc is minimum, based on the error rate and the tracking drive offset amount, wherein
upon recording/reproduction of data to/from the optical disc, the tracking drive offset amount is added to the tracking drive signal.

14. An optical disc recording/reproduction device according to claim 12 configured to multiply a difference between
a tracking drive offset amount derived from the claim 12 device, and
a tracking drive offset amount derived from an optical disc recording/reproduction device comprising: a photo-detector for receiving and detecting a laser beam reflected from an optical disc; means for generating a tracking error signal based on an output from the photo-detector; and means for generating a tracking drive signal based on the tracking error signal, the optical disc recording/reproduction device further comprising:
means for giving a tracking drive offset amount to the tracking drive signal to shift a spot position of the laser beam irradiated on the photo-detector;
means for shifting the spot position of the laser beam irradiated on the photo-detector, reproducing data recorded to the optical disc, and detecting an error rate; and
means for recording a tracking drive offset amount at which the error rate of the data recorded to the optical disc is minimum, based on the error rate and the tracking drive offset amount, wherein
upon recording/reproduction of data to/from the optical disc, the tracking drive offset amount is added to the tracking drive signal,
by a certain ratio to thereby calculate and store a final tracking drive offset amount, and add the final tracking drive offset amount to a tracking drive signal upon recording/reproduction of data to/from an optical disc.
